(19) United States
(12) Patent Application Publication
(10) Pub. No.: US 2010/0096528 A1
(43) Pub. Date: Apr. 22, 2010

(54) FUEL PUMP MODULE SNAP-IN SUPPORT ROD ATTACHMENT

(75) Inventor: Patrick K. Powell, Farmington Hills, MI (US)

Correspondence Address: HARNESS, DICKEY & PIERCE, P.L.C., P.O. BOX 828, BLOOMFIELD HILLS, MI, 48303, US

(73) Assignee: DENSO International America, Inc., Southfield, MI (US)

(21) Appl. No.: 12/414,259

(22) Filed: Mar. 30, 2009

Related U.S. Application Data
(63) Continuation-in-part of application No. 12/288,681, filed on Oct. 22, 2008.

(51) Int. Cl. B42F 13/00; B60P 3/22

(52) U.S. Cl. 248/343; 137/899

(57) ABSTRACT

A connection structure for a fuel pump module flange and support rod may employ a flange having a top plate and a vertical wall that is perpendicular to the top plate. A vertical wall bottom edge may define a bottom edge slot. The flange may further define a recession in the vertical wall that merges with the bottom edge slot. The recession may house semi-circular first and second boss arms that protrude from a ceiling that bounds the recession. First and second semicircular clip arms may reside in the recession and define a gap with the first and second boss arms. A cylindrical rod may have a rod tip that slides between the boss arms and a rod shaft that clips into the clip arms by biasing apart the clip arms. Installation of the rod may be from the side of the flange and not the bottom of the flange.

### CROSS-REFERENCE TO RELATED APPLICATIONS

This application claims priority to, and is a continuation-in-part of, U.S. patent application Ser. No. 12/288,681 filed on Oct. 22, 2008. The entire disclosure of application Ser. No. 12/288,681 is incorporated herein by reference.

### FIELD

The present disclosure relates to a support rod for a fuel pump module, and more particularly, to a snap-in support rod attachment for preventing three-dimensional movement of a support rod for a fuel pump module.

### BACKGROUND

The statements in this section merely provide background information related to the present disclosure and may not constitute prior art. Current fuel pump modules may employ two structures to connect a support rod to a fuel pump module flange. A first structure is a force fitting or interference fit of a rod end into a hole in the plastic flange of the fuel pump module. The hole is normally slightly smaller than the rod diameter at the rod end so that an initially tight interference fit is achieved between the rod and the plastic surrounding the hole. A disadvantage of the interference fit is that stresses are induced into the plastic surrounding the hole and such stresses remain in the plastic. The stress in the plastic material surrounding the hole may cause the plastic to eventually crack, for example, when subjected to by an outside force. The rod may also become loose in the hole due to vibration and movement caused by a vehicle riding upon various road surfaces.

A second structure may employ a general loose-fitting connection between the rod and the plastic surrounding a rod hole with the rod being secured longitudinally with a metal clip, such as an e-clip. However, a disadvantage is that while the support rod may remain within the confines of a hole in the bottom of the flange, such rod may not actually be attached to the flange, that is, the rod is only prevented from being removed from the flange by the clip, yet the rod may move about within the hole. That is, the rod may still move horizontally and vertically to some extent (i.e. in the X, Y and Z directions). Thus, stress in the plastic surrounding the hole may be reduced, yet the fit of the rod in the hole is not tight and noise, vibration and harshness may persist. Additionally, a fit between the rod and the plastic surrounding the hole that is not tight, is not advantageous.

What is needed then is a device that does not suffer from the above disadvantages. This, in turn, will provide a device, such as a flange, that does not have stress imparted to it from an interference fit of a support rod and the flange; furthermore, a fit will be provided between the rod and the flange such that no relative movement is permitted between the rod and the flange, such as in the horizontal directions or vertical direction.

### SUMMARY

A connection structure for a fuel pump module may employ a fuel pump module flange having a top plate and a vertical wall that may be perpendicular to the top plate. The flange may further define a recession or cavity in the vertical wall that houses a first boss arm and a second boss arm. The first and second boss arms may be semi-circular and protrude from a ceiling or top wall that defines part of the recession. Moreover, a first clip arm and a second clip arm may be semicircular and define a gap with the first and second boss arms. A cylindrical rod may have a rod tip and a rod shaft. The rod tip may have a first diameter while the rod shaft may have a first portion with a second diameter that is smaller than the first diameter of the rod tip and a second portion with a third diameter that is equal to the first diameter of the rod tip. The rod tip and the first portion of the rod shaft may reside within the recession. Additional length of the rod shaft may protrude from the recession.

The first boss arm and the second boss arm define a slot within which the rod tip of the cylindrical rod resides within the recession. Just below the boss arms, the first clip arm and the second clip arm together define a slot within which the first portion of the rod shaft resides. A gap may exist between the boss arms and the clip arms. To securely hold the rod shaft, the first clip arm and the second clip arm may be flexible and resilient and conform to the first portion of the rod shaft to hold it against a rear vertical wall that forms part of the recession. A bottom boundary of the vertical wall may define a slot within which the second portion of the rod shaft resides. The second portion of the rod shaft may have a diameter equal to the diameter of the rod tip.

### DRAWINGS

The drawings described herein are for illustration purposes only and are not intended to limit the scope of the present disclosure in any way.

FIG. 1 is a side view of a vehicle depicting a location of a vehicle fuel system;

FIG. 2 is a side view of a vehicle fuel system depicting a fuel pump module within the fuel tank;

FIG. 3 is a perspective view of a fuel tank depicting an aperture for installation of a fuel pump module;

FIG. 4 is a side view of a fuel pump module depicting representative locations of support rods;

FIG. 5 is an enlarged view of a fuel pump module flange and a support rod;

FIG. 6 is an enlarged view depicting a recess in the flange and the support rod for installation into the recess;

FIG. 7 is a side view of a support rod and a fuel pump module flange depicting the structure for securing the rod into the flange;

FIG. 8 is a side view of a support rod installed into a fuel pump module flange structure that secures the rod into the flange;

FIG. 9 is a top cross-sectional view depicting the flange recess and support rod prior to installation of the rod into the flange;

FIG. 10 is a top cross-sectional view depicting the flange recess and support rod at an intermediate step of installation of the rod into the flange;

FIG. 11 is a top cross-sectional view depicting the flange recess and support rod after installation of the rod into the flange;

FIG. 12 is an enlarged side view of a flange depicting a securing structure within a recess of the flange in accordance with another embodiment of the disclosure;

FIG. 13 is an enlarged side view of a flange depicting a rod in the recess of the flange;

FIG. 14 is an enlarged perspective view of a flange depicting a securing structure within a recess of the flange; and

FIG. 15 is an enlarged perspective view of a flange depicting a rod in the recess of the flange.

### DETAILED DESCRIPTION

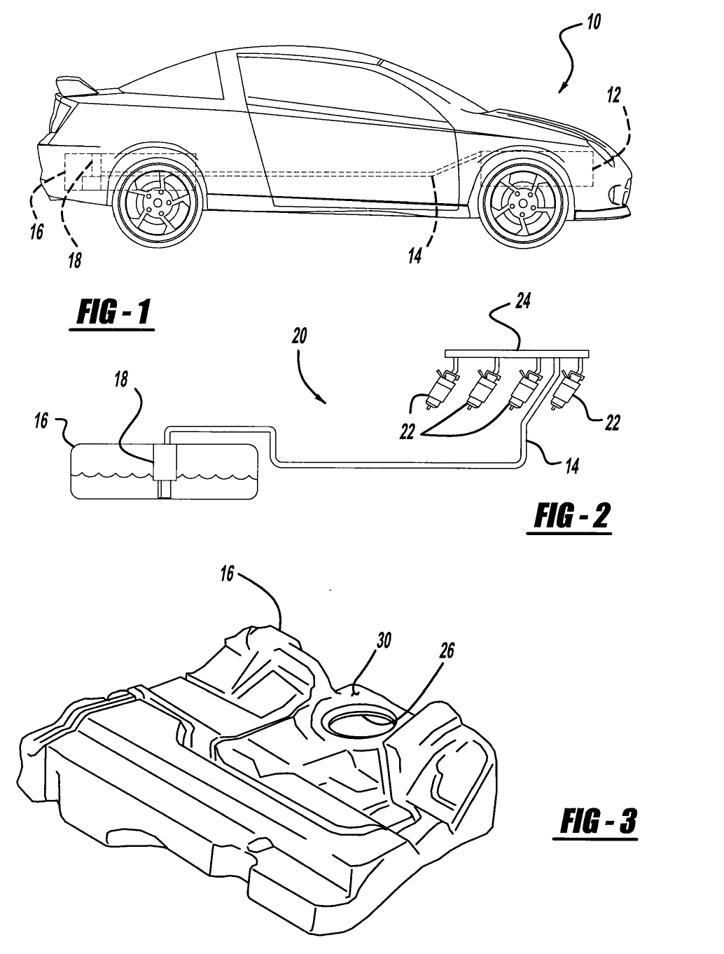

The following description is merely exemplary in nature and is not intended to limit the present disclosure, application, or uses. Throughout the drawings, corresponding reference numerals indicate like or corresponding parts and features. Turning now to FIGS. 1-8, features and details of the present teachings will be presented.

FIG. 1 depicts a vehicle 10, such as an automobile, having an engine 12, a fuel supply line 14, a fuel tank 16, and a fuel pump module 18. The fuel pump module 18 mounts within the fuel tank 16 with a flange and is normally submerged in or surrounded by varying amounts of liquid fuel within the fuel tank 16 when the fuel tank 16 possesses liquid fuel. A fuel pump within the fuel pump module 18 pumps fuel to the engine 12 through the fuel supply line 14.

FIG. 2 is a perspective view of a fuel supply system 20 depicting fuel injectors 22. In a returnless fuel system, only a fuel supply line 14 carries fuel between the fuel pump module 18 and a common fuel injector rail 24. Once the fuel reaches the injector rail 24, also called a “common rail,” as depicted in FIG. 2, the fuel passes into individual fuel injectors 22 before being sprayed or injected into individual combustion chambers of the internal combustion engine 12. The fuel supply system 20 depicted in FIG. 2 has no fuel return line from the injector rail 24 to the fuel tank 16. FIG. 3 is a perspective view of a vehicle fuel tank 16 depicting a mounting location 26, a hole, about which is a mounting surface 30 for a fuel pump module 18.

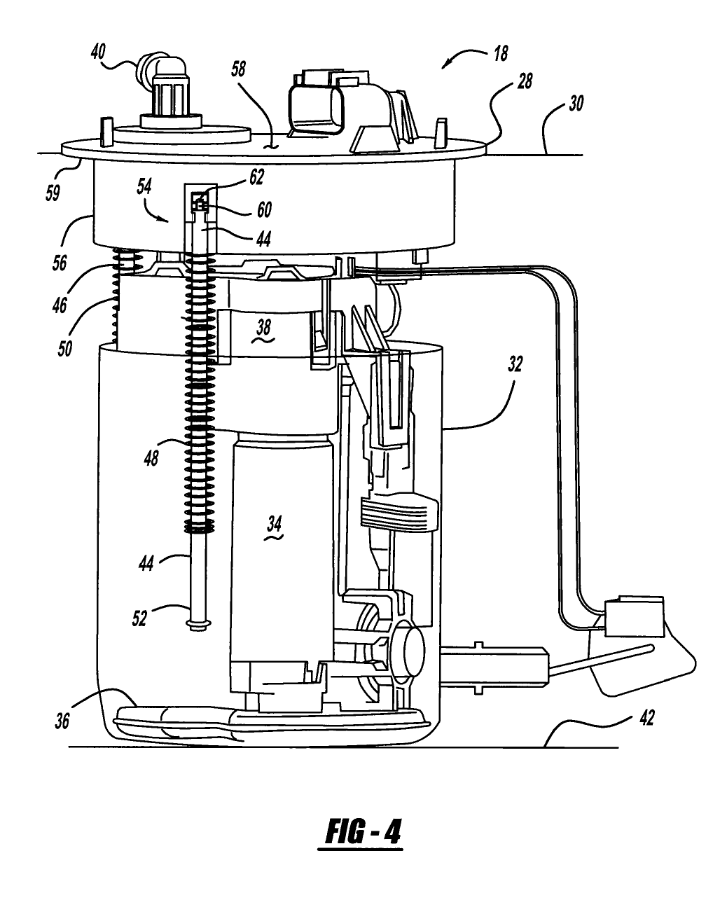

FIG. 4 depicts one embodiment of a fuel pump module 18 that may be lowered through the hole of the mounting location 26 on top of the fuel tank 16 when installed. More specifically, a fuel pump module flange 28 rests on the mounting surface 30 on the top of the fuel tank 16 when the fuel pump module 18 is in its installed position. Additionally, the fuel pump module 18 of FIG. 4 depicts a generally vertical cylindrical reservoir 32. Alternatively, the reservoir 32 may be oriented generally horizontally (not shown). An advantage of a horizontal reservoir is that less fuel tank depth is necessary to accommodate the reservoir. Alternatively, an advantage of a vertically oriented fuel pump module reservoir 32 is that less horizontal space is necessary for its installation and the reservoir itself may be firmly biased against the bottom interior of the fuel tank. That is, generally a vertical reservoir 32 may have a smaller overall diameter than a horizontal reservoir for the same vehicle application.

Continuing with reference to FIG. 4, the fuel pump module 18 includes at least one fuel pump 34 that draws fuel from the reservoir 32 and through a filter sock 36 and, in one example, through a fuel pump check valve 38 that may disposed at or near the top of the fuel pump 34. The fuel pump check valve 38 opens in response to positive pressure from within the fuel pump 34 to permit fuel to flow from the top of the fuel pump and into the fuel supply line 14 via fuel supply line port 40. To successfully pump fuel as generally described above, the fuel pump module 18 resides secured against the bottom interior surface 42 of the fuel tank 16. To maintain its secured position against the bottom interior surface 42 of the fuel tank 16, the fuel pump module 18 utilizes a first rod 44 and a second rod 46. More specifically, the first rod 44 may be surrounded by a first spring 48 and the second rod may be surrounded by a second spring 50. Because the rods 44, 46 function in the same manner, only the first rod 44 will be used to exemplify details of the disclosure.

Continuing with FIG. 4 and first rod 44, a first end 52 of the first rod 44 may be secured to the reservoir 32 in some fashion, such as by using a press fit into a portion of the reservoir 32, or by crimping the first end 52 or installing a washer at the first end 52 after passing it through part of the reservoir 32, such as a flange (not shown). A second end 54 of the first rod 44 may be firmly secured to the reservoir 32 at the flange 28 by a press or snap fit. More specifically, the second end 54 of the first rod 44 may pass through a vertical wall 56 that is perpendicular to a horizontal top 58 of the flange 28.

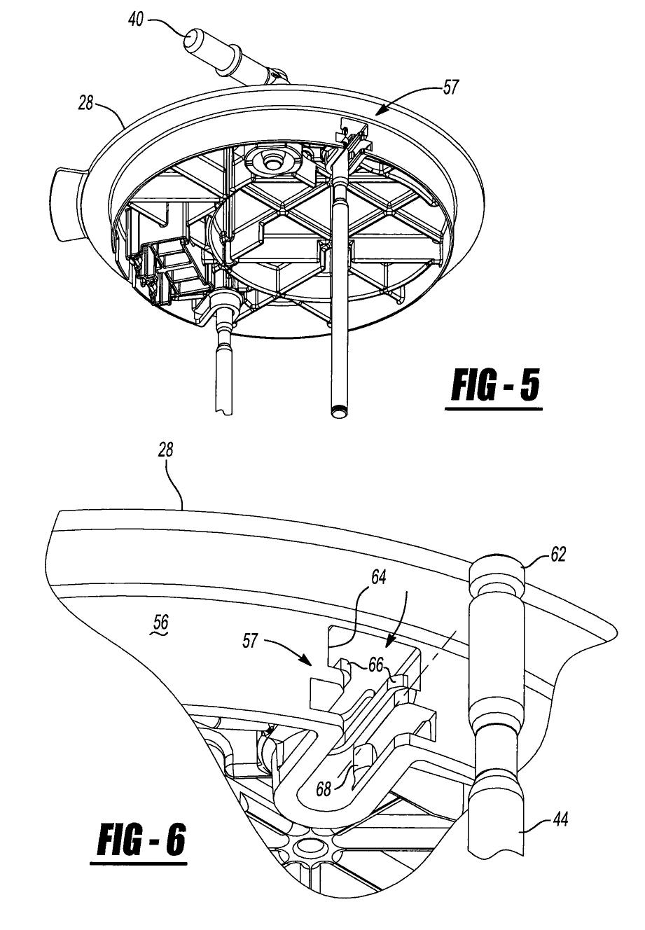

With continued reference to FIG. 4, and additional reference to FIGS. 5-8, further details of the first rod 44, flange 28, and the installation of the rod 44 into the flange 28 will be explained. FIG. 5 depicts a flange 28 with a rod lock 57, which is integrally molded into the flange 28, with the rod 44 installed. FIG. 6 depicts an enlargement of the rod lock 57 area of the flange 28. More specifically, the first rod 44 installs within the recess 64 of the flange 28 from the side of the flange 28. To securely hold the rod 44 in place, a variety of structures in the flange wall 56 are utilized. For instance, a stationary boss 66 and flexible clip 68 are, in part, used to secure the rod 44 in the recession. The flexible clip 68 snaps closed to secure the rod 44 into place.

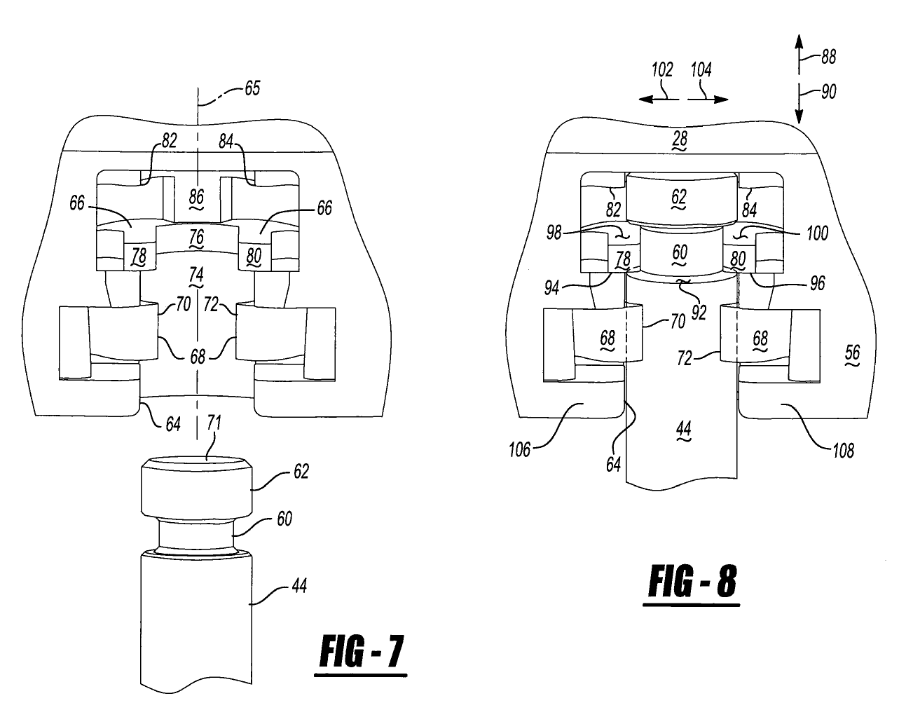

FIGS. 7 and 8 further depict the operative workings of the invention, and will now explained. FIG. 7 depicts the rod 44 with a rod tip 62 and a rod neck 60. Each part of the rod 44 fits into or is accommodated by parts within the recession 64 of the flange 28. Continuing, the recess contains a flexible clip 68 which may employ a first clip arm 70 and a second clip arm 72 that protrude into the recess such that a distance between the arms 70, 72 is less than the diameter of the rod 44 below the neck 60. The recess 64 of the flange 28 further defines a rear wall 74 and a collar 76. The protruding boss 66 has a first boss arm 78 and a second boss arm 80 that are part of the collar 76. Within the recess 64, the flange 28 also employs a first tip arm 82, second tip arm 84, and a rear tip rest 86, which together prevent motion of the rod tip 62 when the rod is installed in the recess 64. The neck 60 of the second end 54 of the first rod 44 may have a neck 60 that is smaller in diameter than the rod diameter on each side of the neck 60. As an example, the first rod 44 may be 6 mm in diameter from the first end 52 to the neck 60, which may be 3.5 mm, with the first rod 44 from the neck 60 to the tip 62 of the second end 54 again having a diameter of 6 mm. The decrease in diameter of the neck 60 in the rod may be in a non-tapered fashion and form 90 degree angles with the larger diameter portions of the rod on each side of the neck 60, such as with the tip 62 and the side of the neck 60 opposite to the tip 62.

Turning now to FIG. 8, a more detailed discussion of the features that prevent the rod 44 from moving upon installation into the recess 64 will be presented. FIG. 8 depicts the rod tip 62 situated at the top of the recess 64 between and in contact with the first tip arm 82 and the second tip arm 84. When in its installed position, the rod tip 62 contacts the rear tip rest 86. On the rod 44 and below the rod tip 62, is the rod neck 60, which is situated within a collar 76, or boss. The collar 76 or boss has a first boss arm 78 and a second boss arm 80 which lie on either side of the neck 60. The neck 60 may contact the first boss arm 78 and second boss arm 80 and the rear of the collar 76. Together, the collar 76 and the boss arms 78, 80 prevent the rod 44 from moving up and down, or vertically, in accordance with arrow 88 and arrow 90. Vertical movement is prevented because the tip 62 of the rod 44 contacts a top surface 98 of the first boss arm 78 and a top surface 100 of the second boss arm 80. The boss arms 78, 80 may contact the neck 60 and reside under the tip 62, as depicted in FIG. 8. In its installed position, the tip 62 may or may not be in contact with the boss arms 78, 80. If not in contact, the space between the bottom of the tip 62 is minimal, such approximately 1 mm. To prevent upward movement of the rod 44 in accordance with the arrow 88, the tip 62 may be positioned against the bottom of the flange 28. Similarly, the land 92 of the rod 44 may contact the bottom surface 94 of the first boss arm 78 or the bottom surface 96 of the second boss arm 80.

Continuing with FIG. 8, to prevent the rod 44 from moving side to side, or in accordance with arrow 102 and arrow 104, the rod tip 62 may be in contact with the first tip arm 82 and second tip arm 84. Alternatively, a small gap, such as less than 3 mm, may remain between the rod tip 62 and the first tip arm 82 and the second tip arm 84. Similarly, the boss arms 78, 80 may contact the neck 60 and prevent movement in accordance with arrows 102, 104. A small gap, such as less than three millimeters, may be present between the neck 60 and the first boss arm 78 and the second boss arm 80, to ease installation and removal of the rod 44.

Continuing with FIG. 8, at the bottom of the recess 64, the flange wall 56 forms a first guide or first post 106 and a second guide or second post 108. Each of the posts 106, 108 protrude toward a vertical centerline of the recess 64 and toward the rod 44 when the rod 44 is installed within the recess 64. A gap, such as less than three millimeters, may lie between the rod 44 and each of the posts 106, 108 to facilitate installation and removal of the rod 44 from the recess 64. The posts 106, 108 prevent movement of the rod 44 in accordance with the arrows 102, 104.

With reference again to FIG. 7, the recession 64 and the component parts that secure the rod 44 in place will be further described. The component parts that lie within or are part of the recess 64 are molded together with the flange 28 and its vertical wall 56. That is, the parts that secure the rod 44 into the flange 28 are integrally molded with the flange 28, and advantage of which is that no parts can become disassembled from the flange 28, rattle, or otherwise permit the rod 44 to move within the recess 64. Therefore, the first and second trip arms 82, 84, the rear tip rest 86, the boss 66 and its collar 76, the boss arms 78, 80, the rear wall 74 and the first and second arms 70, 72, which act as in concert as a flexible clip 68 are integrally molded as part of the flange 28.

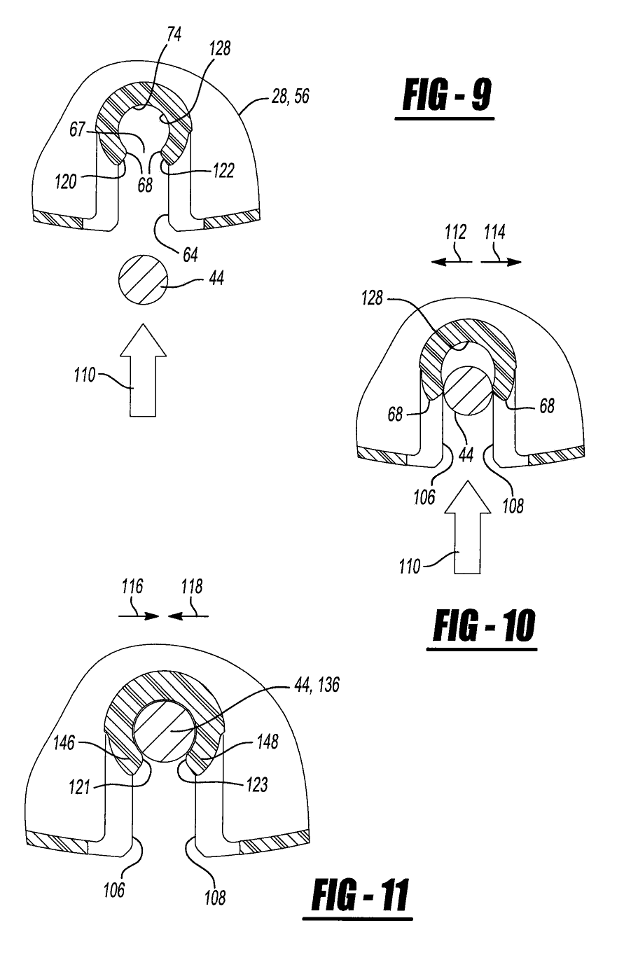

Turning now to FIGS. 9-11, a more detailed description of insertion of the rod 44 into the recession 64 of the flange 28 will be described. FIGS. 9-11 depict a cross-sectional top view through the flexible clip 68 to depict how the flexible clip 68 accepts and grips the rod 44. FIG. 9 depicts the rod 44 spaced away from the recession 64. To insert the rod 44 into the flange 28, the rod 44 may be translated in accordance with arrow 110 toward the rear wall 74, and between the first boss arm 78 and second boss arm 80 that together make up the flexible clip 68. Continuing with FIG. 10, as the rod 44 is moved toward the flexible clip 68, the rod 44 eventually contacts the first clip arm 70 and the second clip arm 72. Upon contact of the rod 44 with the arms 70, 72, the arms 70, 72 will begin to flex outwardly, or away from the moving rod 44, in accordance with arrow 112 and arrow 114. As the rod 44 is inserted into the recess 64, the rod 44 may contact the first post 106 and the second post 108, which together may act as a guide. Turning now to FIG. 11, upon the rod 44 approaching full insertion into the flexible clip 68, the first clip arm 70 will move in accordance with arrow 116 and the second clip arm 72 will move in accordance with arrow 118, or toward each other and further engulfing or encapsulating the rod 44. Since the rod 44 depicted in FIG. 11 is in its fully installed position, the flexible clip 68 is in its relaxed, or non-stressed state, as the flexible clip 68 is in FIG. 9, before installation of the rod 44. As depicted in FIGS. 9 and 11, the shortest distance between the first clip arm 70 and second clip arm 72 is less than the cross-sectional diameter of the rod 44. Because the flexible clip 68 must be forced open, that is, in accordance with arrows 112, 114, to either insert or remove the rod 44, the rod 44 is securely held in place when it is installed and within the confines of the flexible clip 68, as depicted in FIG. 11 and FIG. 8.

With reference again to FIG. 9, although also evident in FIGS. 10-11, the flexible clip 68 has a land 120 and 122, on the first clip arm 70 and the second clip arm 72, respectively. The lands 120, 122 may be a flat or relatively flat surface and form part of the tips 124, 126 of each of the arms 70, 72. Alternatively, the lands 120, 122 may be slightly rounded or crowned. As depicted in FIGS. 9-11, the lands 120, 122 are angled relative to each other such that the largest distance between the lands is at the point on the lands farthest from the receptacle 128, and the shortest distance between the lands 120, 122 is at the point on the lands closest to the receptacle 128. The arrangement of the lands 120, 122 of the flexible clip 68 facilitates installation of the rod 44 into the receptacle 128 in accordance with arrow 110. While insertion of the rod 44 into the receptacle 128 is eased with the arrangement of the lands 120, 122, removal of the rod 44 from the receptacle 128 may be more difficult than insertion. To facilitate installation of the first rod 44 into the recess 64, the land 120 may have a radiused corner 121 while the land 122 may have a radiused corner 123.

An advantage of using the flexible clip 68 for insertion of the rod 44 into the receptacle 128 is that the flexible clip 68 provides positive tactile feedback to a person who is installing the rod 44, even if the installer is not looking at the receptacle 128 and flexible clip 68. More specifically, when the rod 44 is pressed onto and contacts the lands 120, 122, an installer will begin to feel resistance as the flexible clip 68 provides resistance, which increases as the tips 124 and 126 of the flexible clip 68 open in accordance with the arrows 112 and 114, respectively. The resistance increases because the flexible clip 68 acts as a spring and biases against the force that is used to open the flexible clip 68. As long as the flexible clip 68 is being spread open, the resistance will increase; however, upon the diameter of the rod 44 passing the shortest distance between the lands 120, 122, the tips 124, 126 of the flexible clip 68 will begin to close, or come together. As the flexible clip 68 begins and continues to close, as the rod 44 continues its progress toward the rear wall 74, the resistance becomes less and less until the rod 44 is fully inserted into the receptacle, at which point the resistance becomes zero. Because an installer feels the increase and decrease in resistance, one may install the rod with confidence, knowing the installation is proper, even without looking at the flexible clip 68 and receptacle 128. Furthermore, when the rod 44 is installed in one consistent speed, a snapping or popping noise may be heard. The snapping or popping noise may be the noise of the rod 44 striking the rear wall 74 of the receptacle 128.

Therefore, the teachings of the present disclosure include a connection structure for a fuel pump module 18. More specifically, the connection structure may include a rod 44 and a flange 28. The flange 28 may define a top horizontal plate 58, which may be flat on the top and bottom sides, and a vertical wall 56. The vertical wall 56 may define a longitudinal recession 64 or hole open to a side 56, such as a horizontal side, as opposed to the top side or bottom side. The rod 44 may be translated from the side of the flange and into the vertical recession. The vertical wall 56 defining the recession 64 may further define a boss 66, which may protrude horizontally toward a vertical centerline 65 of the recession 64 and into the neck 60 of the rod 44 when the rod 44 is in its installed position. The boss 66 prevents longitudinal, that is, up and down, motion of the rod 44. The neck 60 portion is smaller in diameter than adjacent non-neck rod 44 lengths. The boss 66 demarks or marks a division in the recession 64 between an upper recession 64 and a lower recession 64, between which the neck 60 of the rod 44 resides. The vertical wall 56 may further define a gap between a first clip arm end and a second clip arm end, together which secure the rod 44 when installed within the recession 64. The gap is less than a diameter of the rod 44. During installation of the rod 44 into the recession 64, the rod 44 will “snap” into place when the flexible clip 68 contacts and travels around the rod 44. That is, when fully and properly inserted, an audible “snap” may be heard from the flexible clip 68 while a distinctive feeling of the rod 44 slipping or accelerating out of one's fingers and into the recession 64, from the first clip arm 70 and the second clip arm 72, may also be felt as the flexible clip 68 resumes its resting or closed position, from its tensioned or opened position. The closed position of the flexible clip 68 is depicted in FIGS. 7, 8, 9 and 11. The open position occurs when the rod 44 is positioned between the ends of the flexible clip 68, as in FIG. 10.

In another example, a connection structure for a fuel pump module may employ a rod 44 and a flange 28 defining a top horizontal plate and a vertical wall 56. The vertical wall 56 may define a recession 64 open to a non-top and non-bottom side of the vertical wall 56 within which the rod resides. The recession 64 is open in a horizontal direction from the side of the vertical wall 56. The vertical wall defining the recession may further employ a boss 66 that protrudes toward a vertical centerline 65 of a volume of the recession 64 and into a groove or neck 60 of the rod 44. The boss prevents longitudinal motion, or motion in accordance with arrows 88, 90, of the rod 44. The boss 66 may be a horizontal, semi-circular ring and employ a first boss arm 78 and a second boss arm 80. The recession of the vertical wall 56 may further employ a first protruding boss arm 78 and a second protruding boss arm 80 while the rod 44 may further employ a neck 60 having a diameter smaller than adjacent rod lengths, the neck area 60 of the rod 44 may reside between the first protruding boss arm 78 and the second protruding boss arm 80.

In another example of the above disclosure, a connection structure for attaching a rod to a fuel pump module flange 28 may employ a rod 44 defining a circular groove 60 or neck 60 about the rod circumference while a vertical wall 56 of the flange 28 may define a longitudinal recession 64 open to a horizontal side, as opposed to a top side or a bottom side, of the vertical wall 56 to provide access to the recession 64 through the vertical wall 56. The rod 44 may reside within the recession 64. More specifically, a boss 66 within the recession 64 may protrude toward a vertical centerline 65 of a volume of the recession 64 and around the neck 60 of the rod 44. The boss 66 may be a semi-circular ring and prevent longitudinal motion, such as in accordance with the arrows 88, 90, of the rod 44. The connection structure of the flange 28 may further employ a top plate that may contact a flat end of the rod 44 to prevent the rod 44 from moving vertically. Still yet, a flexible clip 68 may define a first clip arm 70 with a first clip arm end and a second clip arm 72 with a second clip arm end and defining a gap 67 between the first clip arm end and the second clip arm end. A distance between the first clip arm end and the second clip arm end is less than the diameter of the rod on either side of the neck 60. The first clip arm end and the second clip arm end are capable of biasing to enlarge the gap 67 to a distance large enough to permit the rod 44 to pass between the first clip arm end and the second clip arm end, as depicted in FIG. 10.

In yet another example of a connection structure for attaching a rod 44 to a fuel pump module flange 28, the connection structure may employ a rod 44 defining a first rod diameter and a neck 60 defining a second, smaller rod diameter. Additionally, a horizontal flange top may be adjoined to a vertical flange wall 56, which may define a longitudinal (up and down in accordance with arrows 88, 90) recession 64. The rod 44 may reside within the longitudinal recession 64 of the vertical wall. Moreover, the structure may employ a boss 66 with a first boss arm 78 and a second boss arm 80. The boss 66 may demark a division in the longitudinal recession 64 and define an upper recession and a lower recession. The neck 60 of the rod 44 may reside within the boss 66, between the first boss arm 78 and the second boss arm 80. Still yet, the structure may employ a flexible clip 68 defining a first clip arm 70 with a first clip arm end and a second clip arm 72 with a second clip arm end, and define a gap 67 between the first clip arm end and the second clip arm end. A distance between the first clip arm end and the second clip arm end is less than the first rod diameter. An entire length of the longitudinal recession 64 may be exposed through a non-top and non-bottom side of the vertical wall 56. The connection structure may further employ a top plate of the flange 28 and a flat rod end 71 proximate the neck 60 of the rod 44. The flat rod end 71 may contact a bottom surface of the flange 28 to prevent longitudinal motion of the rod 44 when the rod 44 is installed in the longitudinal recession 64.

Continuing, the rod may employ a rod tip 62 while the recession 64 of the vertical wall 56 may further employ a first tip arm 82 and a second tip arm 84. The first tip arm 82 may reside on a first side of the rod tip 62 and the second tip arm 84 may reside on a second side of the rod tip 62. With reference to FIGS. 9-11, the first clip arm 70 may further define a first flat land and the second clip arm 72 may further define a second flat land, the first and second flat lands may contact the rod 44 during installation of the rod 44 in the flexible clip 68. The first clip arm 70 and the second clip arm 72 of the flexible clip 68 may bias to enlarge the gap 67 between the first clip arm end and the second clip arm end. The flange 28, including the horizontal flange top, the first boss arm 78, the second boss arm 80, the first clip arm 70, the second clip arm 72, the first tip arm 82, and the second tip arm 84 may be integrally molded as one piece of material within the vertical recession. One advantage of being an integral piece is that assembly and movement between separate parts is eliminated.

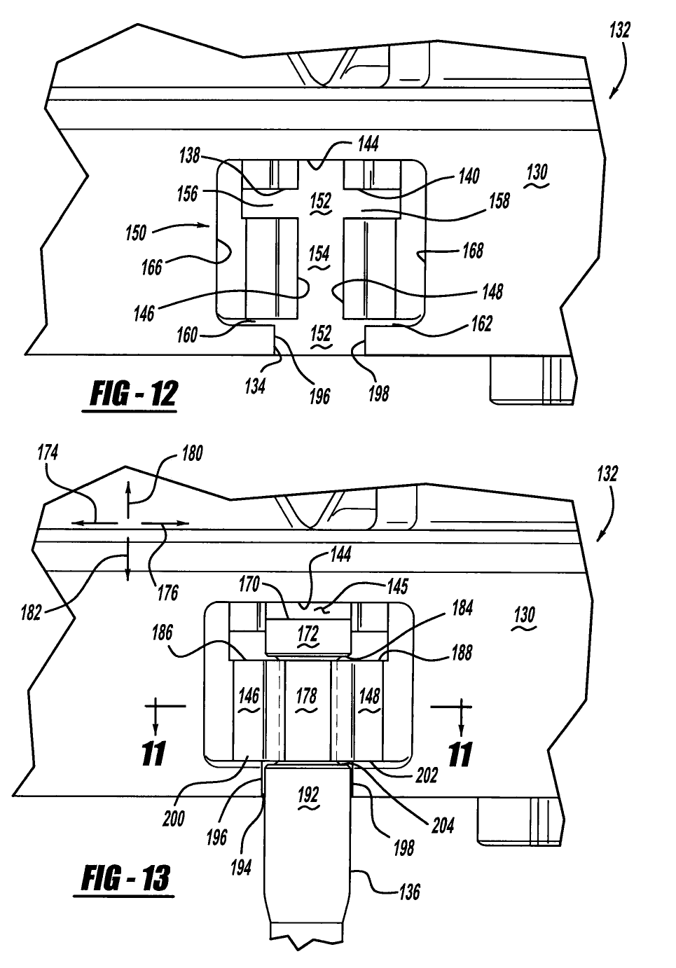

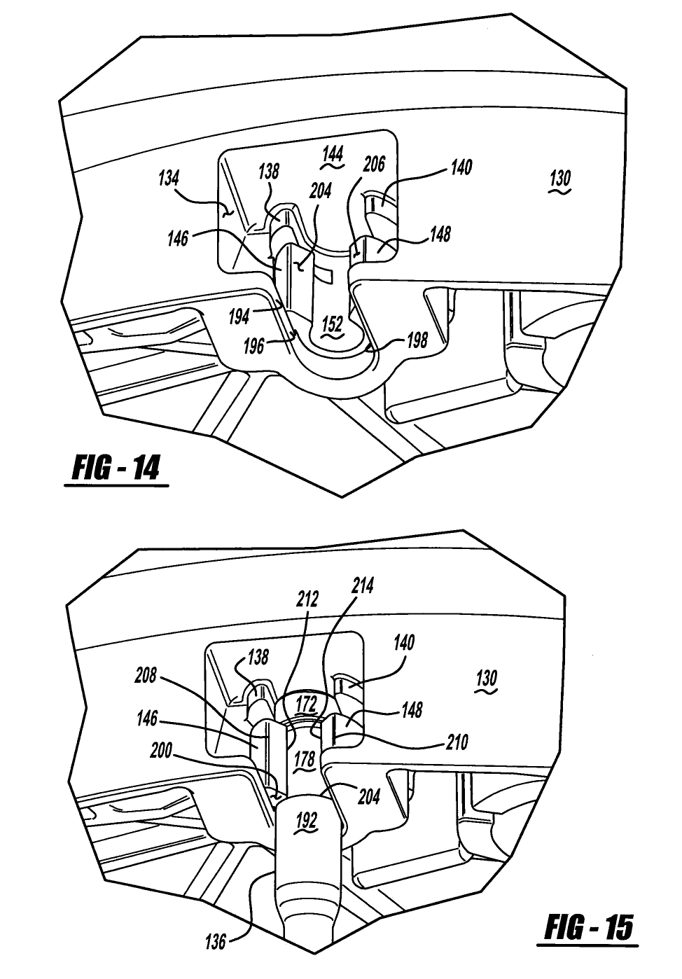

Turning now to FIGS. 12-15, another embodiment of the present disclosure will be described. FIG. 12 depicts a vertical sidewall 130 of a fuel pump module flange 132. The flange 132 has a recession 134 or cavity in the sidewall 130 through with a rod 136 (FIG. 13) may be inserted. More specifically, within the recession 134 and past the exterior plane that is the vertical flange wall 130 of the flange 132, a structure is in place to securely hold the rod 136. Continuing with reference to FIG. 12, within the recession 134, a first boss arm 138 and second boss arm 140 are molded as part of the flange 132 within the recession 134. The boss arms 138, 140 protrude from a rear surface 142 of the recession 134 toward the flange wall 130, but do not protrude beyond the flange wall 130. The boss arms 138, 140 may be a downward extension of the recession ceiling 144, that is, the boss arms 138, 140 may be an integrally molded portion of the molded flange 132. Also within the recession 134, a first clip arm 146 and a second clip arm 148 work together as a flexible clip 150 for securing the rod 136 against a rear wall 152. The clip arms 148, 150 are flexible such that a gap 154 in existence between clip arms 146, 148 is enlarged when rod 136 is pressed into the recession 134 and gap 154. In other words, before installation of the rod 136 into the recession 134, the gap 154 between the clip arms 146, 148 is smaller than the diameter of the rod 136. During insertion of the rod 136 between the clip arms 146, 148, the clip arms 146, 148 separate such that the gap 154 enlarges to the size of the diameter of the cylindrical rod 136 at the section of the rod 136 moving between the clip arms 146, 148. Thus, the clip arms 146, 148 contact the rod 136 during the insertion process and then return to either their pre-insertion position after insertion or remain slightly farther apart than their pre-insertion position so that the clip arms 146, 148 retain a force against the rod 136, which abuts the rear wall 152 that forms the recession 134.

Continuing primarily with reference to FIG. 12, the clip arms 146, 148 protrude into the recession 134 from one side of the clip arm 146, 148. That is, a gap 156 exists between the first clip arm 146 and the first boss arm 138, and a gap 158 exists between the second clip arm 148 and the second boss arm 140. Similarly, a gap 160 exists between first clip arm 146 and flange wall 130, and a gap 162 exists between second clip arm 148 and flange wall 130. As depicted in FIG. 12, gap 160 is located on an opposite side of clip arm 146 as gap 156 and gap 162 is located on an opposite side of clip arm 148 as gap 158. Thus, gaps 156, 160 permit first clip arm 146 to flex or hinge about first clip arm side 166 while gaps 158, 162 permit second clip arm 148 to flex or hinge about second clip arm side 168.

Turning now primarily to FIG. 13, the rod 136 is depicted in its installed position within flange 132, and more specifically, within the cavity 134 of the flange 132. Upon positioning the rod 136 such that a rod top 170 is parallel to a recession ceiling 144, which orients the longitudinal axis of the cylindrical rod 136 perpendicular to the horizontal top 58 (FIG. 4), the rod 136 may be pushed into the recession 134 and against the clip arms 146, 148. Upon causing the clip arms 146, 148 to open, thereby increasing the gap 154 between the clip arms 146, 148, and then further pushing the rod 136 into the recession 134, the clip arms 146, 148 will again move toward each other thereby decreasing the gap 154. Upon the rod 136 reaching its installed position in the flange 136, the rod outside diameter may contact the rear wall 152 that forms part of the cavity 134.

FIG. 13 depicts the rod 136 in its installed position with part of the rod exposed between the clip arms 146, 148 and part of the rod 136 locked or contained between the clip arms 146, 148 and rear wall 152. A cross second of installed rod 136 may be viewed in FIG. 11. Continuing with FIG. 13, at no time during installation do boss arms 138, 140 move or flex and instead, provide rigid boundaries for the rod tip 172 so that rod tip 172 does not move laterally or side to side as indicated with arrows 174, 176, and so that rod 136 remains perpendicular to the horizontal top 58. Because rod 136 is shaped with rod top 172 being larger in diameter than a rod clip section 178, the rod top 170 can not move downwardly, or in a direction in accordance with arrow 182, beyond first clip arm top 186 and second clip arm top 188 because the rod tip bottom 184 will contact the first clip arm top 186 and second clip arm top 188. More specifically, when first clip arm 146 and second clip arm 148 are in position around rod clip section 178 of rod 136, the rod clips 146, 148 form a circular barrier around rod clip section 178 such that interference is created with rod tip 172 so that rod tip 172 can not move past or through the barrier. The rod top 170 may contact the recession ceiling 144 to prevent movement beyond the recession ceiling 144.

Continuing now with FIGS. 13-15, upon installation, the rod 136 has a rod wall section 192 that passes into a slot 194 of the flange wall 130 and resides within part of the flange wall 130. More specifically, the rod wall section 192 resides within the slot 194 between a first slot wall 196 and a second slot wall 198. Together, the slot walls 196, 198 serve a similar function as the boss arms 138, 140, which is to prevent lateral movement or movement consistent with arrows 174 and 176. Additionally, as depicted in FIG. 13, a first clip arm bottom 200 and a second clip arm bottom 202 may be contacted by a land 204 of the rod 136 located immediately next to or above the rod wall section 192 to prevent the rod 136 from moving upward in accordance with arrow 180. Thus, because the diameter of the land 204 is larger than the hole formed by the clip arms 146, 148 when the clip arms 146, 148 are securing the rod 136.

FIGS. 14 and 15 present many of the same features of FIGS. 12 and 13, but using a perspective view. FIG. 14 clearly depicts a first clip arm angle surface 204 and a second clip arm angle surface 206 on the clip arms 146, 148 that facilitate installation of the rod 136 within the confines of the clip arms 146, 148. More specifically, the clip arm angle surface 204 and a second clip arm angle surface 206 are angled relative to each other such that the shortest distance or gap between the leading edge 208 of the first clip arm 146 and the leading edge 210 of the second clip arm 148 is larger than the shortest distance or gap between the trailing edge 210 of the first clip arm 146 and the trailing edge 212 of the second clip arm 148.

Stated slightly differently, a connection structure for a fuel pump module 18 may employ a cylindrical rod 136 with a rod tip 172 and a rod shaft, the rod tip 172 having a first diameter that is larger than a second diameter of a portion of the rod shaft, such as rod clip section 178. Additionally, a flange 132 may define a top horizontal plate 28 and a vertical wall 130. The vertical wall 130 may define a recession 134 open to a non-top and non-bottom side of the vertical wall 130. Part of the rod 136 may reside within the recession 134 and between a first boss arm 138 and a second boss arm 140, which may also reside within the recession. More specifically, the rod tip 172 may reside between the boss arms 138, 140. To facilitate installation, the boss arms 138, 140 may be semi-circular and conform to a circular rod tip 172. The boss arms 138, 140, which reside within the recession 134, may be molded to a ceiling defining part of the recession and actually project downward in accordance with arrow 182 thereby providing fixed lateral support for the rod tip 172.

Continuing with reference to FIGS. 14-15, a first clip arm 146 and a second clip arm 148 may reside within the recession 134 and contact and conform to the second diameter of the rod shaft, which may be of a smaller diameter than the rod tip diameter. A first clip arm angle surface 204 and a second clip arm angle surface 206 may contact the rod 136 exterior during installation of the rod 136 into the recession 134. The clip arms 146, 148 are flexible and resilient and may be attached along one side to a side wall that also defines part of the recession 134. The clip arms 146, 148 may be semi-circular and conform to the rod clip section 178, which may be circular. A bottom boundary of the vertical wall 130 may define a slot 194 within which the second portion (ex. shaft area 192) of the rod shaft 136 resides.

With reference to FIG. 15, a more specific description of a rod shaft 136 will be provided. The rod shaft 136 may have a first portion (ex. rod clip section 178) with a second diameter that is smaller than the first diameter of the rod tip 172, and a second portion (ex. Item 192) with a third diameter that is equal to the first diameter of the rod tip 172. The rod tip 172 and the first portion of the rod shaft may reside within the recession 134. A space 145 may exist above rod tip 172 and below recession ceiling 144.

With reference to FIG. 13, securing the rod 136 within the recession 134 will be discussed. The first clip arm 146 may have a first clip arm top 186 and a first clip arm bottom 200 and the second clip arm 148 may have a second clip arm top 188 and a second clip arm bottom 202. The rod tip 172 may have a rod tip bottom 184 such that the first clip arm top 186 and the second clip arm top 188 contact the rod tip bottom 184 to prevent removal of the rod 136 from the recession 134, such as when clip arms 146, 148 are securely holding the rod 136. The second portion of the rod shaft with a third diameter has a top land 204 that contacts the first clip arm bottom 200 and the second clip arm bottom 202 to prevent upward movement of the rod 136, such as when clip arms 146, 148 are securely holding the rod 136.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A connection structure for a fuel pump module comprising:
a cylindrical rod with a rod tip and a rod shaft, the rod tip having a first diameter that is larger than a second diameter of a portion of the rod shaft;
a flange defining a top horizontal plate and a vertical wall, the vertical wall defining a recession open to a non-top and non-bottom side of the vertical wall within which the rod resides;
a first boss arm; and
a second boss arm, wherein a portion of the rod shaft resides within the recession with the rod tip between the first boss arm and the second boss arm.

2. The connection structure of claim 1, wherein:
the first boss arm and second boss arm are molded to a ceiling defining part of the recession to provide fixed support for the rod; and
the first boss arm and second boss arm reside within the recession.

3. The connection structure of claim 2, further comprising:
a first clip arm residing within the recession; and
a second clip arm, wherein the first and second clip arms contact the second diameter of the rod shaft having a smaller diameter than the rod tip.

4. The connection structure of claim 3, further comprising:
a first clip arm angle surface; and
a second clip arm angle surface, wherein the angle surfaces contact the rod during installation of the rod into the recession.

5. The connection structure of claim 4, wherein the first clip arm and the second clip arm are flexible and resilient.

6. The connection structure of claim 5, wherein the first clip arm and the second clip arm are each attached along one side to a wall defining the recession.

7. A connection structure for a fuel pump module comprising:
a fuel pump module flange having a top plate and a vertical wall that is perpendicular to the top plate, the flange further defining a recession in the vertical wall that houses:
a first boss arm and a second boss arm, wherein the first and second boss arms are semi-circular and protrude from a ceiling that bounds the recession; and
a first clip arm and a second clip arm, wherein the first and second clip arms are semicircular and define a gap with the first and second boss arms.

8. The connection structure of claim 7, further comprising:
a cylindrical rod having a rod tip and a rod shaft, the rod tip having a first diameter, the rod shaft having a first portion with a second diameter that is smaller than the first diameter of the rod tip and a second portion with a third diameter that is equal to the first diameter of the rod tip, wherein the rod tip and the first portion of the rod shaft reside within the recession.

9. The connection structure of claim 8, wherein the first boss arm and the second boss arm define a slot within which the rod tip of the cylindrical rod resides.

10. The connection structure of claim 9, wherein the first clip arm and the second clip arm define a slot within which the first portion of the rod shaft resides.

11. The connection structure of claim 10, wherein the first clip arm and the second clip arm are flexible and resilient and conform to the first portion of the rod shaft.

12. The connection structure of claim 11, wherein a bottom boundary of the vertical wall defines a slot within which the second portion of the rod shaft resides.

13. A connection structure for a fuel pump module comprising:
a fuel pump module flange having a top plate and a vertical wall that is perpendicular to the top plate; and
a vertical wall bottom edge that defines a bottom edge slot, the flange further defining a recession in the vertical wall that merges with the bottom edge slot, wherein the recession houses:
a first boss arm and a second boss arm, wherein the first and second boss arms are semi-circular and protrude from a ceiling that bounds the recession; and
a first clip arm and a second clip arm, wherein the first and second clip arms are semicircular and define a gap with the first and second boss arms.

14. The connection structure of claim 13, further comprising:
a cylindrical rod having a rod tip and a rod shaft, the rod tip having a first diameter, the rod shaft having a first portion with a second diameter that is smaller than the first diameter of the rod tip and a second portion with a third diameter that is equal to the first diameter of the rod tip, wherein the rod tip and the first portion of the rod shaft reside within the recession.

15. The connection structure of claim 14, wherein the first boss arm and the second boss arm define a slot within which the rod tip of the cylindrical rod resides.

16. The connection structure of claim 15, wherein the first clip arm and the second clip arm define a slot within which the first portion of the rod shaft resides.

17. The connection structure of claim 16, wherein the first clip arm and the second clip arm are flexible and resilient and conform to the first portion of the rod shaft.

18. The connection structure of claim 17, wherein the first clip arm further comprises a first clip arm top and a first clip arm bottom and the second clip arm 148 further comprises a second clip arm top and a second clip arm bottom.

19. The connection structure of claim 18, wherein the rod tip further comprises a rod tip bottom and the first clip arm top and the second clip arm top contact the rod tip bottom to prevent removal of the rod from the recession.

20. The connection structure of claim 19, wherein the second portion of the rod shaft with the third diameter has a top land that contacts the first clip arm bottom and the second clip arm bottom to prevent upward movement of the rod.
